(19) United States
(12) Patent Application Publication
(10) Pub. No.: US 2012/0147508 A1
(43) Pub. Date: Jun. 14, 2012

(54) Three phase multi-generator ground fault circuit

(75) Inventor: Richard Starkweather, Hopewell Estates, IL (US)

(73) Assignee: CATERPILLAR INC., Peoria, IL (US)

(21) Appl. No.: 12/962,835

(22) Filed: Dec. 8, 2010

(51) Int. Cl. H02H 3/16

(52) U.S. Cl. 361/48

(57) ABSTRACT

A ground loop detection and prevention system includes multiple electric power generators driven by one or more rotational power sources. Each of the electrical generators has a set of generator windings with a neutral point. A transformer having a number of primary windings as well as a secondary winding is connected to the neutral points via the primary transformer windings. An interrupter device such as a GFCI is connected across the transformer's secondary winding, such that when a ground loop current occurs in any of the generator windings, the interrupter device detects the loop and stops the operation of the generators.

### TECHNICAL FIELD

This patent disclosure relates generally to electrical power generation, and more particularly to a system for ground loop detection in generator neutral lines.

### BACKGROUND

Electrical power generators are commonplace today, both as stand-alone generators and as components of another system. For example, a utility backup generator facility contains a number of electrical generators as well as a power source for providing rotational energy to the generators. These components are housed in a stationary enclosure and are connected to remote consumers via electrical power cables. Similarly, in the transportation field, a railway locomotive typically includes a number of electrical generators and a diesel engine for driving the generators, with all of these components being carried on a common mobile chassis.

Whatever the setting, there are certain issues that are common to both stationary and mobile generator sets (gensets). A significant issue is the existence of ground loops, and the harm such loops can cause. A ground loop is a current loop within lines that are ostensibly at the same voltage. In other words, while electrically interconnected points are theoretically assumed to be at the same electrical potential, the material actually utilized for such interconnections has resistance, and thus differs from the ideal resistance-free conductor assumed in the theoretical models.

As such, voltage changes at one of the interconnected points may result in a voltage differential between interconnected points. This differential gives rise to a current within the associated conductors. This unwanted current is referred to as a ground loop. In addition to wasting electrical energy and providing unexpected radio frequency interference, such loops are also capable of destroying conductive components of the generator such as windings, cabling, etc.

In multiphase generator systems, generator neutral lines may be linked and grounded to ground the system and its output. In this context, ground loops often arise in the interconnected neutral lines, causing damage to system components. Thus, it is important to be able to locate and remedy any such ground loops.

While the first step in remedying a ground loop in a generator system is the identification of the loop, ground loop currents through generator neutrals are notoriously difficult to detect using conventional methods. For example, the use of hand held clamp n current meters may not detect sporadic loop issues, and will also not allow the detection of more continuous loop currents that do not induce a strong reaction in inductive sensors.

While the disclosed principles herein are directed at least in part to overcoming one or more disadvantages, noted or otherwise, it will be appreciated that the innovation herein is defined by the attached claims without to regard to whether and to what extent the specifically claimed embodiment overcomes one or more of the noted problems in the existing technology. Moreover, it will be appreciated that any discussion herein of any reference or publication is merely intended as an invitation to study the indicated reference itself, and is not intended to replace or supplement the actual reference. To the extent that the discussion of any reference herein is inconsistent with that reference, it will be appreciated that the reference itself is conclusive as to its teachings.

### SUMMARY

In one aspect, the disclosed generator system includes a plurality of electrical generators configured for connection to one or more rotational power sources, with each of the electrical generators having a set of generator windings with a neutral point. A transformer having a number of primary windings as well as a secondary winding is connected to the neutral points via the primary transformer windings. An interrupter device such as a GFCI is connected across the transformer's secondary winding, and is configured to stop the operation of the generators when a ground loop current occurs in any of the generator windings.

In another aspect, a method of detecting a ground loop current in a generator system includes connecting a plurality of multi-phase electrical generators to a rotational power source, and linking the neutral point of each set of generator windings to a respective primary winding of a multi-phase transformer. A secondary winding of the multi-phase transformer is linked to an interrupter device configured to stop the operation of the plurality of generators when triggered. In this way, a ground loop current occurring in any set of the generator windings will create a voltage differential across the secondary winding, triggering the interrupter device and stopping the operation of the plurality of generators.

In yet another aspect, a generator ground loop detection system includes a multiphase transformer having a secondary winding and a plurality of primary windings inductively linked to the secondary winding. A ground link is connected to one end of each primary winding, and the opposite end of each primary winding is configured or made available for attachment to respective generator winding neutral points. An interrupter device is attached across the secondary winding to trigger based on current flow in any of the primary windings.

It is to be understood that both the foregoing general description and the following detailed description are exemplary and explanatory only and are not restrictive of the invention. Further aspects and features of the disclosed principles will be appreciated from the following detailed description and the accompanying drawings, of which:

### BRIEF DESCRIPTION OF THE DRAWINGS

FIG. 1 is a circuit diagram of a genset and ground loop detection and prevention system in accordance with the described principles;

FIG. 2 is a linearized schematic of a multiphase transformer usable in various implementations of the described principles;

FIG. 3 is a circuit diagram of a four-generator genset and ground loop detection and prevention system in accordance with the described principles; and

FIG. 4 is a linearized schematic of an extended multiphase transformer having linked three-phase transformers usable in various implementations of the described principles.

### DETAILED DESCRIPTION

This disclosure relates to detection of ground loop faults in genset systems. As noted above, in multiphase generator systems, generator neutral lines may be linked and grounded to ground the system and its output. The occurrence of ground loops, while potentially damaging, may be difficult to detect using conventional methods prior to such damage.

In an embodiment of the described principles, a three-phase transformer is configured for linkage to the neutral connection on each genset, causing any circulating currents to induce an output voltage on the secondary coil of the linked three-phase transformer. This induced output voltage is then detected in one embodiment via connection of the three-phase transformer output to a current sensor such as the sensing inputs of a single GFCI. In this way, the GFCI can provide a ground fault detection function.

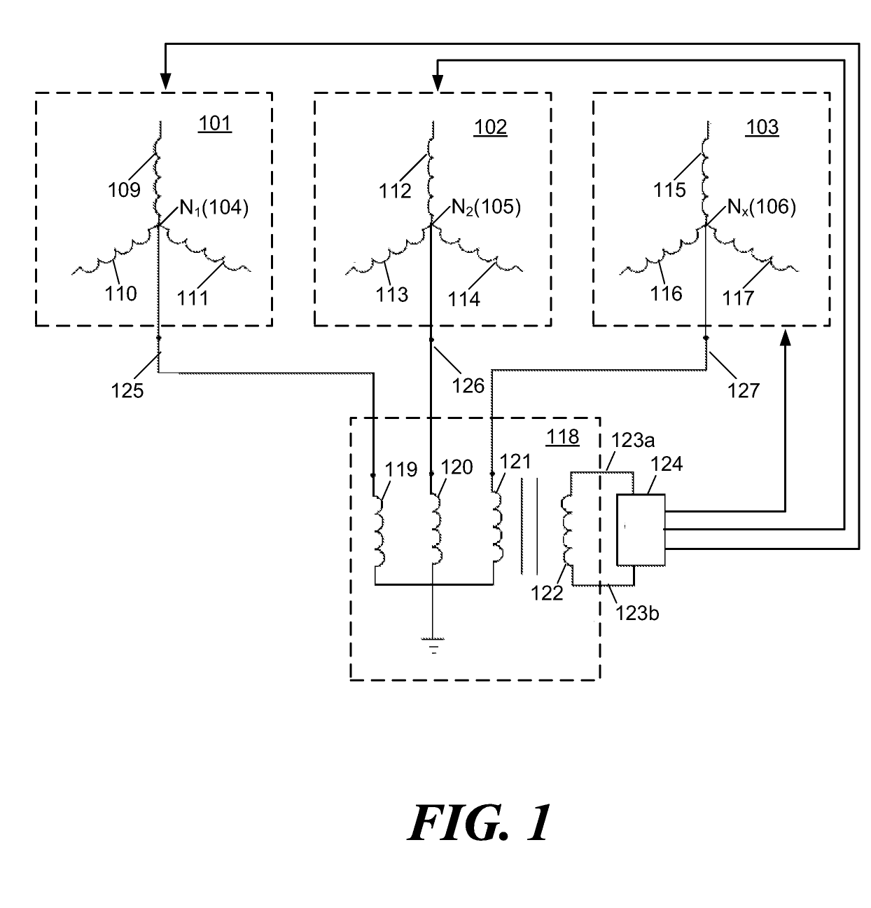

Given this overview, and turning now to FIG. 1, this figure illustrates a circuit schematic of a multiple generator ground loop detection system and configuration 100. The illustrated configuration includes genset having a plurality of three-phase generators 101, 102, 103. Although three generators are shown, it will be appreciated that a greater or lesser number of generators may be used depending upon user preference.

Each generator includes three windings, such that the first generator 101 includes winding 109, winding 110, and winding 111, the second generator 102 includes winding 112, winding 113, and winding 114, and the third generator 103 includes winding 115, winding 116, and winding 117. Each generator 101, 102, 103 is powered by an engine or other power source (not shown in FIG. 1), which turns a rotor (not shown) within the respective windings, also referred to as stator windings. The motion of the rotor induces a current and related voltage within each winding, which is collected as the generator output. As will be appreciated by those of skill in the art, other generator components such as voltage regulators, diode bridges, etc. are omitted from FIG. 1 for clarity.

Each generator winding set has a neutral point tied in DC to the neutral points of the other winding sets. Thus, the neutral point N₁ (104) of generator 101 is tied to the neutral point N₂ (105) of generator 102 and the neutral point N₃ (106) of generator 103. Although tied with respect to DC, the neutral points 104-106 may experience potential differences with respect to AC activity. In particular, such tying is usually by way of conductors having an inherent though ideally minimal resistance value. Moreover, in the illustrated embodiment, respective windings of a three-phase transformer 118 are interposed in the connectors 125-127 between winding neutral points.

In particular, the three-phase transformer 118 includes three primary windings 119, 120, 121, inductively linked to a secondary coil 122. In an embodiment, the output leads 123a, 123b of the three-phase transformer 118 are connected to a GFCI (ground fault circuit interrupter) device 124. A GFCI traditionally operates by sensing a current imbalance indicative of a ground fault, which is a fault to ground rather than a ground loop. However, in the illustrated implementation, the GFCI device 124 will react to the three-phase transformer by triggering if the transformer is energized by ground loop currents. In this way, any ground loop currents between connectors 125-127 induced by differential voltages will be transformed by the three-phase transformer 118 into a voltage signal that triggers the GFCI device 116. When the GFCI device 116 is triggered, it interrupts power to the generators and stops electrical power generation until the operator corrects the ground loop condition, resets the GFCI device 116, and restarts power generation.

It will be appreciated that the three-phase transformer 110 is adapted in size and capacity to withstand and react to the possible ground loop current levels in any given implementation. Thus, for example, the three-phase transformer used to implement the described principles in a stationary municipal power facility may differ from the three-phase transformer used to implement the described principles in a locomotive application.

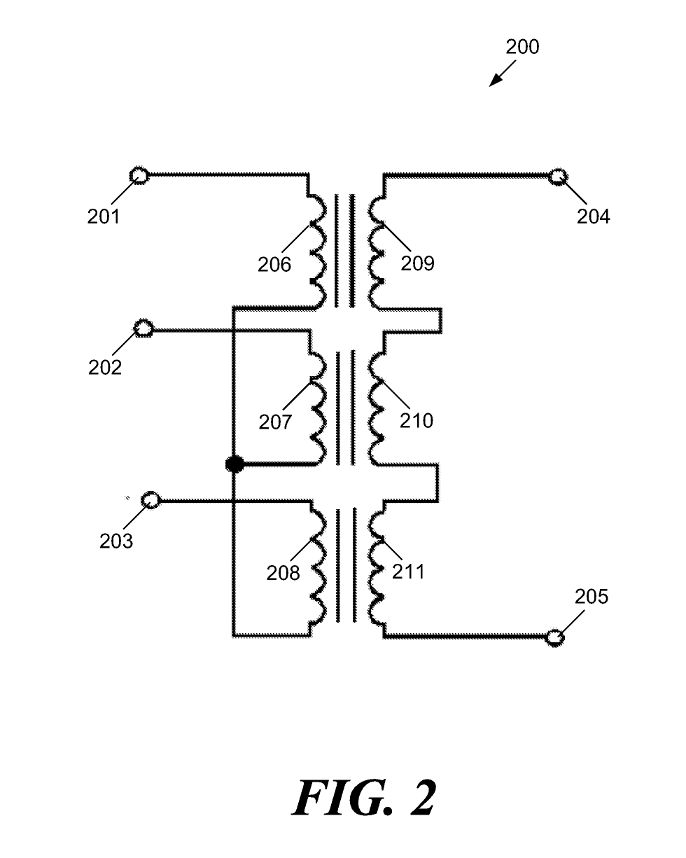

FIG. 2 is a schematic diagram of a multi-phase transformer usable in the system configuration of FIG. 1. The illustrated multi-phase transformer 200 may be physically implemented as a toroidal transformer, though illustrated in linear form for clarity. The multi-phase transformer 200 exposes multiple inputs 201, 202, 203 for tying to three separate generator neutral points. The multi-phase transformer 200 provides two outputs 204, 205 configured to show a voltage differential in the event that any of the inputs 201, 202, 203 provides a current signal.

Each input, e.g., input 201, input 202, and input 203, is in series with a respective primary coil, e.g., primary coil 206, primary coil 207, and primary coil 208. The opposite ends of the primary coils are linked. A secondary coil, e.g., secondary coil 209, secondary coil 210, and secondary coil 211, is associated with each primary coil 206, 207, 208. The secondary coils 209, 210, 211 are linked in series with one another, with the ends of the series serving as the multi-phase transformer 200 outputs 204, 205.

In this configuration, if there are no ground loops, there will be no current in any of the primary coils 206, 207, 208. Thus, there will be no induced voltage across the multi-phase transformer 200 outputs 204, 205. On the other hand, if there is any current in any primary coil 206, 207, 208, there will be a corresponding current and induced voltage in the series connected secondary coils 209, 210, 211, resulting in an induced voltage across the multi-phase transformer 200 outputs 204, 205.

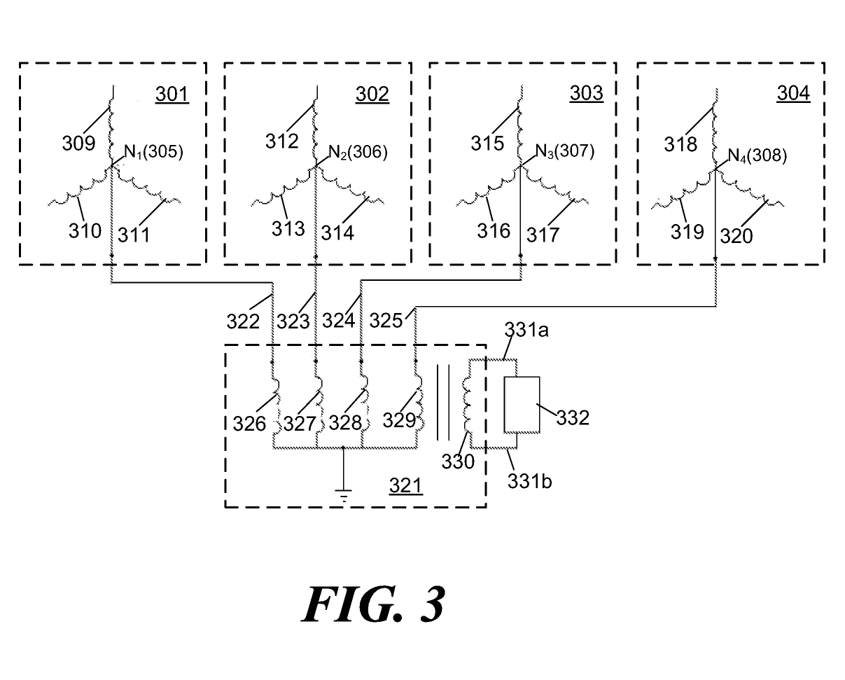

Although FIGS. 1 and 2 show the use of three generators and three primary transformer coils, it will be appreciated by those of skill in the art that the described principles are applicable to detect ground loops in gensets having any number of generators. In this regard, FIG. 3 is a schematic illustration of an extendable four-generator ground loop detection system and configuration 300. The illustrated configuration includes genset having four three-phase generators 301, 302, 303, 304. As with system 100, each generator in system 300 includes three windings, such that the first generator 301 includes winding 309, winding 310, and winding 311, the second generator 302 includes winding 312, winding 313, and winding 314, the third generator 303 includes winding 315, winding 316, and winding 317, and the fourth generator 304 includes winding 318, winding 319, and winding 320.

Each generator 301, 302, 303, 304 includes a rotor (not shown) powered by an engine or other rotational power source. As with FIG. 1, other generator components such as voltage regulators, diode bridges, etc. are omitted from FIG. 3 for clarity. Each generator winding set has a neutral point tied in DC to the neutral points of the other winding sets. Thus, the neutral point N₁ (305) of generator 301 is tied to the neutral point N₂ (306) of generator 302, the neutral point N₃ (307) of generator 303 and the neutral point N₄ (308) of generator 304. Respective windings of a multi-phase transformer 321 are interposed in the connectors 322-325 between winding neutral points 305-308.

In particular, the multi-phase transformer 321 includes four primary windings 326, 327, 328, 329 inductively linked to a secondary coil 330. In an embodiment, the output leads 331a, 331b of the multi-phase transformer 321 are connected to a GFCI (ground fault circuit interrupter) device 332. A GFCI traditionally operates by sensing a current imbalance indicative of a ground fault, which is a fault to ground rather than a ground loop. However, in the illustrated implementation, the GFCI device 332 reacts to the three-phase transformer by triggering if the transformer is energized by ground loop currents.

In this way, any ground loop currents between connectors 322-325 induced by differential voltages will be transformed by the multi-phase transformer 321 into a voltage signal that triggers the GFCI device 332. When the GFCI device 332 is triggered, it interrupts power to the generators 301, 302, 303, 304 and stops electrical power generation until the operator corrects the ground loop condition, resets the GFCI device 332, and restarts power generation.

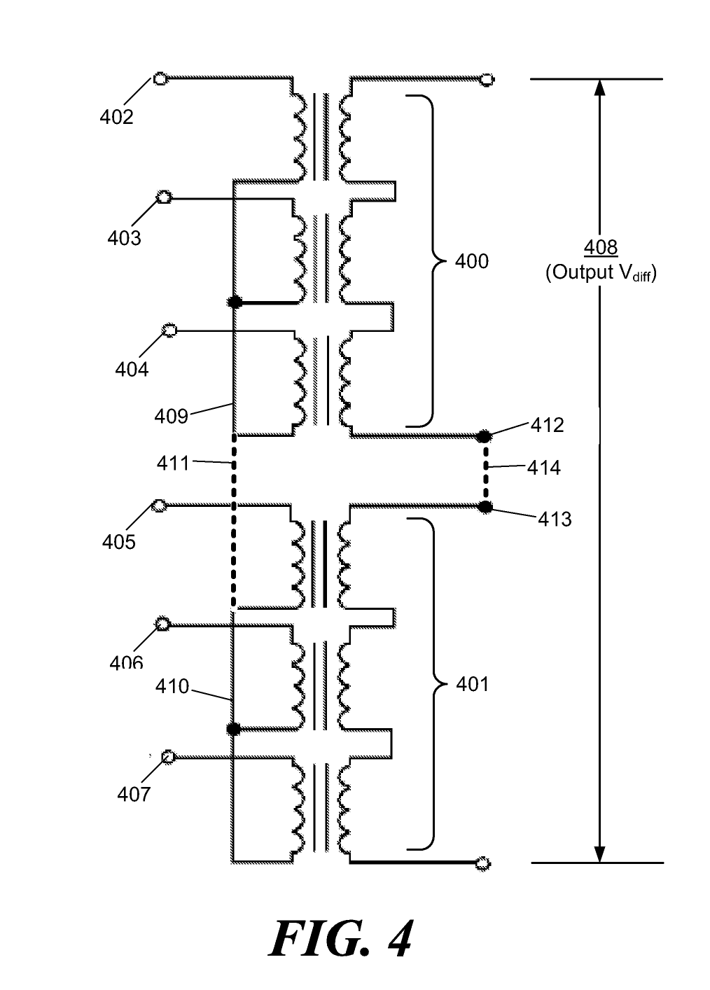

Although the toroidal transformer of FIG. 2 transforms only three power leads, it is possible to use the same type of transformer for more than three power leads. For example, referring to FIG. 4, two such transformers may be configured in series to transform up to six power leads. In the illustrated embodiment, the transformers 400, 401 are connected in series to transform six power leads 402, 403, 404, 405, 406, 407 into a voltage differential output 408.

In order to configure the transformers 400, 401 to react in this way, in the illustrated embodiment the coil common line 409 of the first transformer 400 is linked to the coil common line 410 of the second transformer 401 via a connector 411. Similarly, the lower output lead 412 of the first transformer 400 is linked to the upper output lead 413 of the second transformer 401 via a connector 414. Again, as discussed above, the transformers 400, 401 should have appropriate size and capacity for the anticipated load, to avoid damage to the transformers 400, 401. In an embodiment using multiple transformers wired together, it is desirable, though not critical, to match the transformers.

### INDUSTRIAL APPLICABILITY

The described principles are applicable to machines and devices requiring the generation of electrical power in an environment where ground loops may occur. Such devices include utility back-up generators, primary utility generators, electric vehicle generators, locomotive generators, and so on.

The described principles allow the detection of ground loops before such ground loops can extensively damage a generator or associated circuitry. The use of a dedicated transformer group allows the system to react to a ground loop on any generator winding and trip a GFCI when such currents occur. The operator may then remediate the ground loop condition and reset the GFCI prior to restarting power generation, thereby avoiding damage to the generator and other components.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A generator system comprising:
a plurality of electrical generators configured for connection to one or more rotational power sources, each of the plurality of electrical generators including a set of generator windings, each set of generator windings having a neutral point;
a transformer having a plurality of primary windings and a secondary winding, each primary winding being connected to a generator neutral point; and
an interrupter device connected across the secondary winding and configured to stop the operation of the plurality of generators when triggered, such that a ground loop current occurring in any set of generator windings will result in a voltage differential across the secondary winding, triggering the interrupter and stopping the operation of the plurality of generators.

2. The generator system according to claim 1, wherein the plurality of electrical generators comprise a plurality of three-phase electrical generators.

3. The generator system according to claim 1, wherein the one or more rotational power sources include a diesel engine.

4. The generator system according to claim 1, wherein the interrupter device connected across the secondary winding comprises a GFCI.

5. The generator system according to claim 1, wherein the transformer having a plurality of primary windings and a secondary winding is a single three-phase transformer.

6. The generator system according to claim 1, wherein the transformer having a plurality of primary windings and a secondary winding comprises a plurality of multi-phase transformers.

7. The generator system according to claim 6, wherein the plurality of multi-phase transformers are interconnected.

8. The generator system according to claim 7, wherein each of the plurality of multi-phase transformers includes a secondary winding, and the secondary windings of the plurality of multi-phase transformers are connected in series, with the interrupter device being connected across the end points of the series.

9. The generator system according to claim 1, wherein each of the plurality of primary windings is grounded at one end.

10. A method of detecting a ground loop current in a generator system including a plurality of multi-phase electrical generators, each having a set of generator windings with a neutral point, a rotational power source for driving the plurality of multi-phase electrical generators, the method comprising:
connecting the plurality of multi-phase electrical generators to the rotational power source;
linking the neutral point of each set of generator windings to a respective primary winding of a multi-phase transformer; and
linking a secondary winding of the multi-phase transformer to an interrupter device configured to stop the operation of the plurality of generators when triggered, such that a ground loop current occurring in any set of generator windings will result in a voltage differential across the secondary winding, triggering the interrupter device and stopping the operation of the plurality of generators.

11. The method of detecting a ground loop current according to claim 10, wherein the plurality of electrical generators comprise a plurality of three-phase electrical generators.

12. The method of detecting a ground loop current according to claim 10, wherein the one or more rotational power sources include a diesel engine.

13. The method of detecting a ground loop current according to claim 10, wherein linking the secondary winding of the multi-phase transformer to an interrupter device includes linking a secondary winding of the multi-phase transformer to a GFCI.

14. The method of detecting a ground loop current according to claim 10, wherein linking the neutral point of each set of generator windings to a respective primary winding of a multi-phase transformer includes linking the neutral point of each set of generator windings to a respective primary winding of a three-phase transformer.

15. The method of detecting a ground loop current according to claim 10, wherein linking the neutral point of each set of generator windings to a respective primary winding of a multi-phase transformer includes linking the neutral point of each set of generator windings to respective primary windings of a plurality of multi-phase transformers.

16. The method of detecting a ground loop current according to claim 15, wherein linking a secondary winding of the multi-phase transformer to an interrupter device further comprises linking the series connected secondary windings of the plurality of multi-phase transformers to the interrupter device.

17. The method of detecting a ground loop current according to claim 10, further comprising grounding an end of each primary winding.

18. A generator ground loop detection system comprising:
a multiphase transformer having a secondary winding and a plurality of primary windings inductively linked to the secondary winding;
a ground link connected to one end of each primary windings, the opposite end of each primary winding being available for attachment to one of a plurality of generator winding neutral points; and
an interrupter device attached across the secondary winding to trigger based on current flow in any of the primary windings.

19. The ground loop detection system according to claim 18, wherein the interrupter device is a GFCI.

20. The ground loop detection system according to claim 18, wherein the transformer comprises a plurality of multi-phase transformers having secondary windings connected in series.
